(19) United States
(12) Patent Application Publication
(10) Pub. No.: US 2008/0238892 A1
(43) Pub. Date: Oct. 2, 2008

(54) PIXEL CIRCUIT

(75) Inventor: Yu-Wen Chiou, Sinshih Township (TW)

Correspondence Address: LOWE HAUPTMAN HAM & BERNER, LLP, 1700 DIAGONAL ROAD, SUITE 300, ALEXANDRIA, VA, 22314, US

(73) Assignee: HIMAX TECHNOLOGIES LIMITED, Sinshih Township (TW)

(21) Appl. No.: 11/692,280

(22) Filed: Mar. 28, 2007

(51) Int. Cl. G06F 3/038

(52) U.S. Cl. 345/204

(57) ABSTRACT

A pixel circuit has a light emitting diode, a driving transistor, a capacitor, and a switch unit. The driving transistor has a first source/drain coupled to one end of the light emitting diode. The capacitor is coupled between a gate of the driving transistor and the end of the light emitting diode. The switch unit couples the gate and a second source/drain of the driving transistor together, and couples the second source/drain of the driving transistor to a data line when a scan signal is asserted.

### BACKGROUND

1. Field of Invention

The present invention relates to a pixel circuit, and more particularly relates to an AMOLED voltage type compensation pixel circuit.

2. Description of Related Art

FIG. 1A shows an organic light emitting diode pixel circuit of the prior art. The pixel circuit is a voltage type compensation pixel circuit. The pixel circuit has a light emitting diode 110, a driving transistor 120, a capacitor 130, a first transistor 141, and a second transistor 142. The driving transistor 120 has a first source/drain 121 coupled to one end 111 of the light emitting diode 110, and a second source/drain 122 coupled to a power source end 170 (V_{SOURCE}). The capacitor 130 is coupled between a gate 123 of the driving transistor 120 and the end 111 of the light emitting diode 110. When a scan signal (SCAN) is asserted, the first transistor 141 couples the gate 123 and the second source/drain 122 of the driving transistor 120 together, and the second transistor 142 couples the first source/drain 121 of the driving transistor 120 to a data line 250.

FIG. 1B shows the waveform diagrams of the signals of the embodiment shown in FIG. 1A. The scan signal turns on the first transistor 141 and the second transistor 142 in a data writing stage. The voltages (V_{SOURCE}) of the power source end 170 vary from high voltage (V_{cc}) to low voltage (GND). The voltage of the power source end 170 is GND and VCC respectively in the data writing stage and a display stage. The pixel circuit needs a reset signal (Vᵣₑₛₑₜ) before data writing.

The drawback of the conventional pixel circuit is that it needs a complicated design for variable power voltages and a reset signal.

### SUMMARY

According to one embodiment of the present invention, the pixel circuit has a light emitting diode, a driving transistor, a capacitor, and a switch unit. The driving transistor has a first source/drain coupled to one end of the light emitting diode. The capacitor is coupled between a gate of the driving transistor and the end of the light emitting diode. The switch unit couples the gate and a second source/drain of the driving transistor together, and couples the second source/drain of the driving transistor to a data line when a scan signal is asserted.

According to another embodiment of the present invention, the pixel circuit has a light emitting diode, a driving transistor, a capacitor, and a switch unit. The driving transistor has a first source/drain coupled to one end of the light emitting diode. The capacitor is coupled between a gate and a second source/drain of the driving transistor. The switch unit couples the gate and the first source/drain of the driving transistor together, and couples the second source/drain of the driving transistor to a data line when a scan signal is asserted.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1A shows an organic light emitting diode pixel circuit of the prior art;

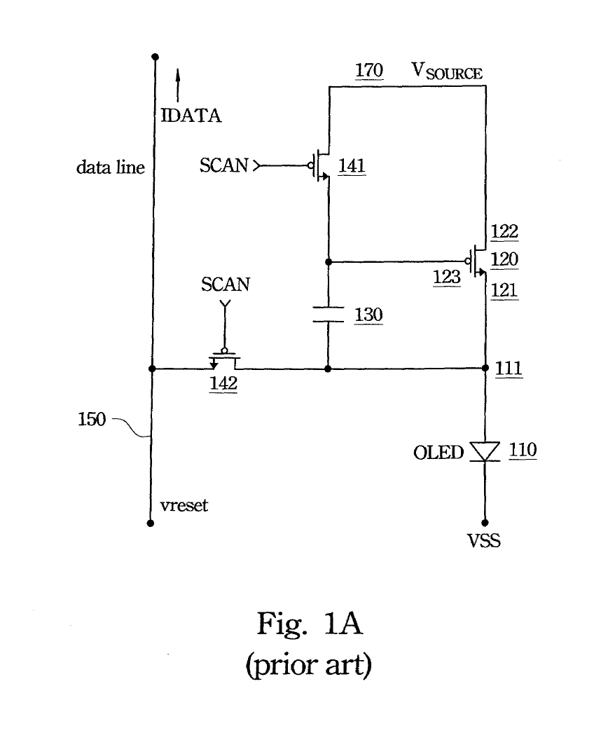

FIG. 1B shows the waveform diagrams of the signals of the embodiment shown in FIG. 1A;

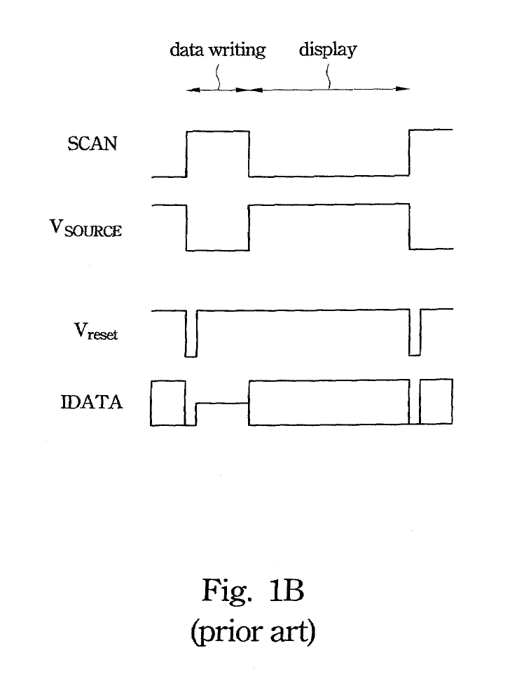

FIG. 2A shows an organic light emitting diode pixel circuit according to an embodiment of the invention;

FIG. 2B shows the waveform diagrams of the signals of the embodiment shown in FIG. 2A; and

FIG. 2C shows an organic light emitting diode pixel circuit according to another embodiment of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

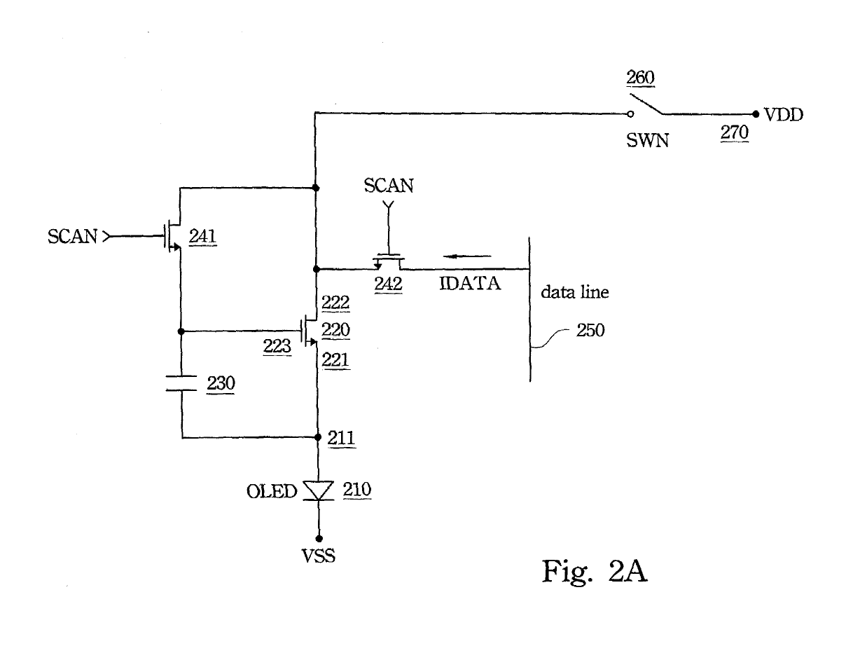

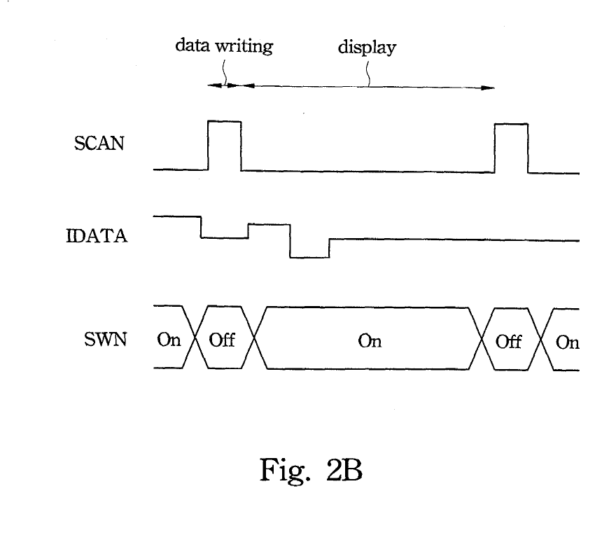

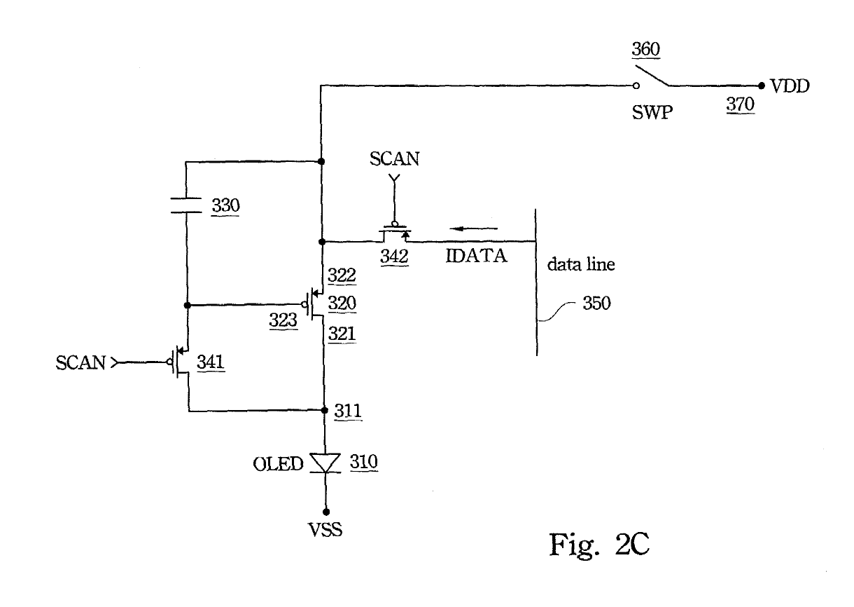

FIG. 2A shows an organic light emitting diode pixel circuit according to an embodiment of the invention. The pixel circuit is a voltage type compensation pixel circuit with NMOS transistors. The pixel circuit has a light emitting diode 210, a driving transistor 220, a capacitor 230, and a switch unit. The driving transistor 220 has a first source/drain 221 coupled to one end 211 of the light emitting diode 210. The capacitor 230 is coupled between a gate 223 of the driving transistor 220 and the end 211 of the light emitting diode 210. When a scan signal (SCAN) is asserted, the switch unit couples the gate 223 and a second source/drain 222 of the driving transistor 220 together, and couples the second source/drain 222 of the driving transistor 220 to a data line 250. Therefore, when the scan signal is asserted, the data signals (IDATA) from the data line 250 are transmitted to the pixel circuit.

The switch unit has a first switch 241 and a second switch 242. The first switch 241 is connected between the second source/drain 222 and the gate 223 of the driving transistor 220. The second switch 242 is connected between the second source/drain 222 of the driving transistor 220 and the data line 250. Moreover, the pixel circuit has a third switch 260 controlled by a signal (SWN) to couple or decouple the second source/drain 222 of the driving transistor 220 to a power source end 270. The third switch 260 can be implemented outside the pixel circuit, such as the margin of the panel or the gat driver, to reduce the amount of the transistors inside the pixel circuit.

FIG. 2B shows the waveform diagrams of the signals of the embodiment shown in FIG. 2A. The scan signal (SCAN) turns off the first switch 241 and the second switch 242 during a data writing stage, and turns on the first switch 241 and the second switch 242 during a display stage.

The signal SWN that controls the third switch 260 is opposite to the scan signal (SCAN). When the signal SWN is deasserted (i.e. the scan signal is asserted) in the data writing stage, the third switch 260 decouples the second source/drain 222 of the driving transistor 220 to a power source end 270. When the signal SWN is asserted (i.e. the scan signal is deasserted) in the display stage, the third switch 260 couples the second source/drain 222 of the driving transistor 220 to the power source end 270.

The second source/drain 222 of the driving transistor 220 floats when the third switch 260 is turned off (i.e. during the data writing stage). Therefore, the data signals can be written into the capacitor 230 of the pixel circuit more easily during the data writing stage. Compared with the pixel circuit of the prior art, the pixel circuit doesn't need an extra reset signal before data writing. Moreover, the power source end 270 can only supply a fixed voltage rather than the variable voltage of the conventional pixel circuit.

The first switch 241, the second switch 242, and the driving transistor 220 use NMOS transistors. If the first switch 241, the second switch 242, and the driving transistor 220 use NMOS transistors, the control signals have to be inverted.

Moreover, if the third switch 260 uses a different type of MOS from the first switch 241 and the second switch 242, the third switch 260 can be controlled by the scan signal (SCAN). For example, if the first switch 241 and the second switch 242 are NMOS transistors, and the third switch 260 is a PMOS transistor, the first switch, second switch and third switch can be controlled by the same scan signal (SCAN). Therefore, there are fewer control signals.

FIG. 2C shows an organic light emitting diode pixel circuit according to another embodiment of the invention. The pixel circuit is a voltage type compensation pixel circuit with PMOS transistors. The pixel circuit has a light emitting diode 310, a driving transistor 320, a capacitor 330, and a switch unit. The driving transistor 320 has a first source/drain 321 coupled to one end 311 of the light emitting diode 310. The capacitor 330 is coupled between a gate 323 and a second source/drain 322 of the driving transistor 320. When a scan signal is asserted, the switch unit couples the gate 323 and the first source/drain 321 of the driving transistor 320 together, and couples the second source/drain 322 of the driving transistor 320 to a data line 350. Therefore, when the scan signal is asserted, the data signals (IDATA) from the data line 350 are transmitted to the pixel circuit.

The switch unit has a first switch 341 and a second switch 342. The first switch 341 is connected between the first source/drain 321 and the gate 323 of the driving transistor 320. The second switch 342 is connected between the second source/drain 322 of the driving transistor 320 and the data line 350. Moreover, the pixel circuit has a third switch 360 controlled by a signal (SWP) to couple or decouple the second source/drain 322 of the driving transistor 320 to a power source end 370.

From the description above, the embodiments of this invention with the voltage compensation function has with three transistors have high aperture ratio. Otherwise, these embodiments can operate without an extra reset signal before writing data.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A pixel circuit, comprising:
a light emitting diode;
a driving transistor having a first source/drain coupled to one end of the light emitting diode;
a capacitor coupled between a gate of the driving transistor and the end of the light emitting diode; and
a switch unit, when a scan signal is asserted, coupling the gate and a second source/drain of the driving transistor together, and coupling the second source/drain of the driving transistor to a data line.

2. The pixel circuit as claimed in claim 1, wherein the switch unit comprises a first switch connected between the second source/drain and the gate of the driving transistor.

3. The pixel circuit as claimed in claim 2, wherein the first switch is a NMOS transistor.

4. The pixel circuit as claimed in claim 1, wherein the switch unit comprises a second switch connected between the second source/drain of the driving transistor and the data line.

5. The pixel circuit as claimed in claim 4, wherein the second switch is a NMOS transistor.

6. The pixel circuit as claimed in claim 1, wherein the pixel circuit receives a data signal from the data line when the scan signal is asserted.

7. The pixel circuit as claimed in claim 1, further comprising a third switch decoupling the second source/drain of the driving transistor to a power source end when the scan signal is asserted, and coupling the second source/drain of the driving transistor to the power source end when the scan signal is deasserted.

8. The pixel circuit as claimed in claim 7, wherein the third switch is turned off when the scan signal is asserted, and the third switch is turned on when the scan signal is de-asserted.

9. A pixel circuit, comprising:
a light emitting diode;
a driving transistor having a first source/drain coupled to one end of the light emitting diode;
a capacitor coupled between a gate and a second source/drain of the driving transistor; and
a switch unit, when a scan signal is asserted, coupling the gate and the first source/drain of the driving transistor together, and coupling the second source/drain of the driving transistor to a data line.

10. The pixel circuit as claimed in claim 9, wherein the switch unit comprises a first switch connected between the first source/drain and the gate of the driving transistor.

11. The pixel circuit as claimed in claim 10, wherein the first switch is a PMOS transistor.

12. The pixel circuit as claimed in claim 9, wherein the switch unit comprises a second switch connected between the second source/drain of the driving transistor and the data line.

13. The pixel circuit as claimed in claim 12, wherein the second switch is a PMOS transistor.

14. The pixel circuit as claimed in claim 9, wherein the pixel circuit receives a data signal from the data line when the scan signal is asserted.

15. The pixel circuit as claimed in claim 9, further comprising a third switch decoupling the second source/drain of the driving transistor to a power source end when the scan signal is asserted, and coupling the second source/drain of the driving transistor to the power source end when the scan signal is deasserted.

16. The pixel circuit as claimed in claim 15, wherein the third switch is turned off when the scan signal is asserted, and the third switch is turned on when the scan signal is de-asserted.
